(19) United States
(12) Patent Application Publication
(10) Pub. No.: US 2007/0186248 A1
(43) Pub. Date: Aug. 9, 2007

(54) Analog broadcasting receiving device and DVD recorder equipped with the same

(75) Inventor: Yoshihisa Nakaya, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/702,228

(22) Filed: Feb. 5, 2007

(30) Foreign Application Priority Data
Feb. 7, 2006 (JP) 2006-030139

(51) Int. Cl. H04N 5/445; G06F 3/00; G06F 13/00; H04N 7/16; H04N 7/173

(52) U.S. Cl. 725/58; 725/39; 725/136; 725/134

(57) ABSTRACT

An analog broadcasting receiving device includes a receiving portion for receiving a television broadcasting wave, an EPG extracting portion for extracting EPG data from VBI of the television broadcasting wave, a ROM for storing drive start time of the EPG extraction portion, and a control portion for controlling each portion. The analog broadcasting receiving device outputs a screen that prompts to change the drive start time to desired time. When the desired time is input, the drive start time before the change is deleted while drive start time after the change is stored. When the drive start time after the change has passed, the drive start time after the change is deleted while the drive start time before the change is stored.

This application is based on Japanese Patent Application No. 2006-030139 filed on Feb. 7, 2006, the contents of which are hereby incorporated by reference.

### BACKGROUND OF THE INVENTION

1. Field of the Invention

The present invention relates to an analog broadcasting receiving device that utilizes an EPG and a DVD recorder equipped with the device.

2. Description of Related Art

Conventionally, there are widespread techniques of superimposing character signals on broadcasting waves of terrestrial analog broadcasting so as to transmit an EPG (Electronic Program Guide) about genre, broadcasting time and the like of broadcasting programs. This EPG is extracted by a broadcasting receiving device such as a television broadcasting receiving device and is displayed on a television screen as a program list. Thus, a televiewer can search his or her favorite program. This broadcasting receiving device is also provided to a video tape recorder, a DVD (Digital Versatile Disc) recorder, an HDD (Hard Disk Drive) recorder or the like.

FIG. 7 is a schematic diagram to show a system structure of a G guide system 100 for displaying an EPG on a television screen. The G guide system 100 in a transmission side converts program guide information prepared by broadcasting companies into a predetermined file format, which is compressed and enciphered. After that, the program guide information is organized by inserting the character signal in VBI (Vertical Blanking Interval) of the television broadcasting wave and is transmitted to broadcasting receiving devices from a transmission device. On the other hand, a receiving side receives the television broadcasting wave by the broadcasting receiving device, extracts the character signal from the VBI as data, which are stored temporarily in a memory or the like. After that, the data are decoded and expanded so that the above mentioned predetermined file is extracted and displayed on the television screen as the program list.

There are various proposals about receiving of the EPG. For example, JP-A-11-234645 discloses a digital broadcasting receiving terminal device that changes the time of data receiving if a user is watching a picture whose data cannot be received when the set time of data receiving has come.

In addition, JP-A-2005-168046 discloses a receiving device, in which corresponding receiving start time is set when a regional number is set, and a waiting operation is performed for a predetermined period of time before and after the receiving start time.

In addition, JP-A-2001-45397 discloses an electronic program guide display updating method for updating the EPG at a timing desired by the user or at a predetermined interval of time.

In addition, JP-A-2004-336649 discloses a digital broadcasting receiving device. According to this document, an EPG acquisition setting screen is displayed on a monitor as an EPG acquisition setting menu provided to the user so that the user can set a condition for obtaining program information. This display is performed so that the user can select on the EPG acquisition setting screen one of options including “setting time” for setting acquisition time of one channel and “setting program type” for setting a type of the program. If the user selects the “setting time” or the “setting program type”, an EPG data acquisition screen is displayed, and program information is obtained for all receivable channels by the designated acquisition time or the designated program type.

The above mentioned documents describe techniques about the EPG of the digital broadcasting. Although the EPG of the digital broadcasting is transmitted together with image data and audio data corresponding to each channel, the EPG of the terrestrial analog broadcasting is transmitted by using VBI of a specific television broadcasting wave as a combined program list of channels. For this reason, a technique of using the EPG on the receiver side is also different between the digital broadcasting and the analog broadcasting.

In the EPG of analog broadcasting, e.g., in the EPG of the G guide system 100 described above, broadcasting time of the EPG is fixed. In Osaka area of Japan, for example, it is 6:05, 11:05, 14:35, 17:35 and 1:45. However, the broadcasting time can be changed due to circumstances of the broadcasting station. If there is a change, it is notified in advance by newspapers and other media.

For example, if the broadcasting time is changed from 14:35 to 15:00, an ordinary analog broadcasting receiving device may try to receive the EPG at 14:35 to fail and does not try to receive at 15:00. It is because that the device is programmed to receive at 14:35, and this setting cannot be changed. As a result, the EPG that was received at 11:05 is displayed from 11:05 to 17:35. It means that the user cannot use the latest EPG from 15:00 to 17:35, and the user cannot use the EPG effectively.

### SUMMARY OF THE INVENTION

In view of the above described problem, it is an object of the present invention to provide an analog broadcasting receiving device that can receive the EPG even if the broadcasting time of the EPG is changed, so that the latest EPG can be provided to the user. In addition, another object of the present invention is to provide a DVD recorder equipped with the analog broadcasting receiving device.

To attain the above described first object, an analog broadcasting receiving device in accordance one aspect of the present invention includes: a receiving portion for receiving a television broadcasting wave; an EPG extracting portion for extracting EPG data from VBI of the television broadcasting wave; a memory portion for storing drive start time of the EPG extraction portion; and a control portion for controlling each portion. And the analog broadcasting receiving device is characterized by a structure in which the drive start time can be changed to desired time.

According to this structure, if the broadcasting time of the EPG is changed, the EPG can be received at the time after the change when the drive start time of the EPG extraction portion is changed by the user.

In the analog broadcasting receiving device described above, the drive start time after the change is preferably valid only once.

According to this structure, since the EPG is transmitted at the usual broadcasting time of the EPG before the change on the next day, it can be received normally.

To attain the above described second object, a DVD recorder equipped with an analog broadcasting receiving device in accordance another aspect of the present invention includes: a receiving portion for receiving a television broadcasting wave; an EPG extracting portion for extracting EPG data from VBI of the television broadcasting wave; a ROM for storing drive start time of the EPG extraction portion; and a control portion for controlling each portion. And the DVD recorder is characterized by a structure in which a screen is output that prompts to change the drive start time to desired time, when the desired time is input, the drive start time before the change is deleted while drive start time after the change is stored, and when the drive start time after the change has passed, the drive start time after the change is deleted while the drive start time before the change is stored.

According to the present invention, even if the broadcasting time of the EPG is changed, the user can change the receiving time of the EPG manually so that the EPG can be received. Thus, the user can use the latest EPG.

### BRIEF DESCRIPTION OF THE DRAWINGS

FIG. 1 is a block diagram to show a structure of a DVD recorder according to the present invention.

FIG. 2 is a block diagram to show a structure of an EPG extraction portion and a control portion shown in FIG. 1 according to the present invention.

FIG. 3 is a flowchart to show an operation of the DVD recorder in an EPG receiving time setting mode according to the present invention.

FIG. 4 is a diagram to show an example of an EPG receiving time setting screen according to the present invention.

FIG. 5 is a diagram to show an example of an input acceptance screen according to the present invention.

FIG. 6 is a diagram to show an example of a schedule screen of the EPG receiving time after alteration according to the present invention.

FIG. 7 is a schematic diagram to show a system structure of a conventional G guide system.

### DESCRIPTION OF THE PREFERRED EMBODIMENTS

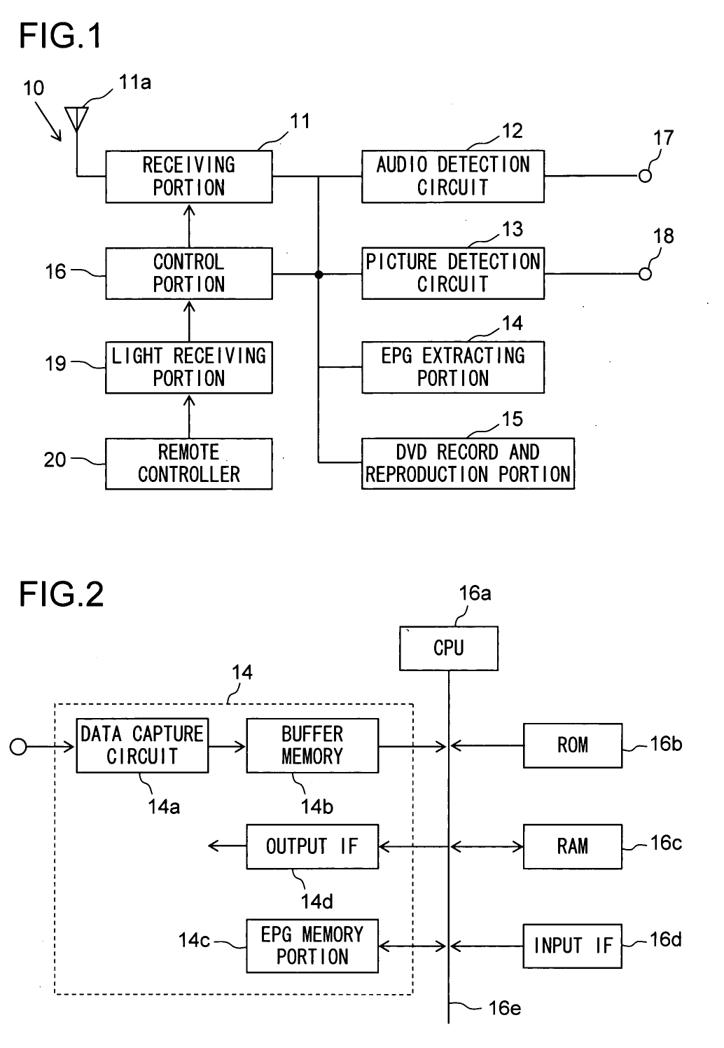

Now, a DVD recorder equipped with an analog broadcasting receiving device will be described as an example with reference to the accompanied drawings. FIG. 1 is a block diagram to show a structure of a DVD recorder, and FIG. 2 is a block diagram to show a structure of an EPG extraction portion and a control portion shown in FIG. 1. At this point FIGS. 1 and 2 show only structures necessary for describing the present invention, and other structures that are not necessary to describe are omitted. The DVD recorder 10 is made up of a receiving portion 11, an audio detection circuit 12, a picture detection circuit 13, an EPG extraction portion 14, a DVD record and reproduction portion 15, a control portion 16, an audio output terminal 17, a picture output terminal 18, a light receiving portion 19, a remote controller 20 and the like.

The receiving portion 11 is equipped with an antenna 11a, and it has a function as a tuner that receives broadcasting waves from broadcasting stations by the antenna 11a and selecting a desired broadcasting program for receiving. The receiving portion 11 extracts a picture signal and an audio signal in the received broadcasting wave and outputs the picture signal and the audio signal to the picture detection circuit 13 and the audio detection circuit 12, respectively. In addition, the receiving portion 11 outputs the broadcasting wave to the EPG extracting portion 14 for extracting a character signal that is superimposed on the broadcasting wave.

The audio detection circuit 12 detects the audio signal out of the picture signal and the audio signal that are input from the receiving portion 11. This audio signal is amplified by an amplifier circuit (not shown) and is output from the audio output terminal 17. The audio output terminal 17 is connected to a speaker (not shown) of a television broadcasting receiving device or the like.

The picture detection circuit 13 detects the picture signal out of the picture signal and the audio signal that are input from the receiving portion 11. This picture signal is amplified by an amplifier circuit (not shown) and is output from the picture output terminal 18. The picture output terminal 18 is connected to a monitor (not shown) of a television broadcasting receiving device or the like.

The EPG extracting portion 14 obtains the EPG by extracting the character signal that is superimposed on the broadcasting wave and is transmitted. The EPG includes information of the broadcasting programs about a program name, broadcasting date, program start time, program end time, a reservation code, a channel, a genre and the like for approximately two weeks, and the information is stored in an EPG memory portion (see FIG. 2).

The DVD record and reproduction portion 15 records the received broadcasting program on a loaded DVD or reproduces data recorded on a DVD.

The control portion 16 drives and controls each portion of the DVD recorder 10 in accordance with a system program and a control program when a tuning operation, a mode selection operation or the like transmitted from the remote controller 20 is input via a light receiving portion 19.

With reference to FIG. 2, the EPG extracting portion 14 and the control portion 16 will be described in detail. As shown in FIG. 2, the EPG extracting portion 14 is made up of a data capture circuit 14a, a buffer memory 14b, an EPG memory portion 14c, an output interface (hereinafter referred to as an IF) 14d and the like. In addition, the control portion 16 is made up of a CPU (Central Processing Unit) 16a, a memory portion including a ROM (Read Only Memory) 16b and a RAM (Random Access Memory) 16c, an input IF 16d and the like. Then, each portion of the EPG extracting portion 14 and each portion of the control portion 16 are connected to each other by bus 16e.

The data capture circuit 14a extracts the character signal from the picture signal input from the receiving portion 11. The character signal is EPG data inserted in a VBI of the picture signal. Then, the data capture circuit 14a performs synchronous reproduction and error correction of the character signal, and the result thereof is stored in the buffer memory 14b temporarily. The buffer memory 14b outputs the stored EPG data on a page basis to the EPG memory portion 14c in accordance with control of the CPU 16a.

The EPG memory portion 14c stores the EPG data that are transmitted from the buffer memory 14b on a page basis, and it updates and stores the EPG at the time when the EPG is transmitted from the transmission device on the transmission side by control of the CPU 16a. The output IF 14d outputs the EPG read out from the EPG memory portion 14c to the monitor.

The CPU 16a works based on a control program stored in the ROM 16b and control data stored in the RAM 16c. The CPU 16a controls a timing of the character signal in the data capture circuit 14a and transmission of data from the data capture circuit 14a to the buffer memory 14b. In addition, the CPU 16a transmits the EPG data stored in the buffer memory 14b temporarily to the EPG memory portion 14c for storing the same on a page basis.

The CPU 16a controls the EPG extracting portion 14 to obtain new EPG data at the time when the EPG is transmitted from the transmission device on the transmission side. Thus, the EPG stored in the EPG memory portion 14c can be updated.

In addition, when an instruction for displaying the EPG is input from the remote controller 20, the CPU 16a reads out the EPG from the EPG memory portion 14c and outputs the EPG from the output IF 14d so that the EPG can be displayed on the monitor.

The input IF 16d outputs an operational instruction input via the light receiving portion 19 to the CPU 16a.

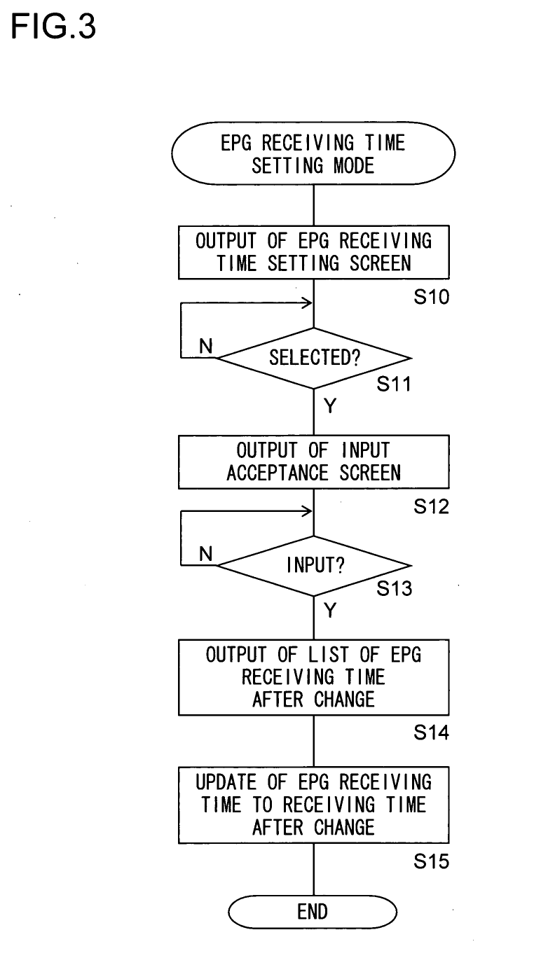

In addition, the control portion 16 performs also a control of an EPG receiving time setting mode for the user to change EPG receiving time. Hereinafter, the EPG receiving time setting mode will be described. FIG. 3 is a flowchart to show an operation of a DVD recorder 10 in the EPG receiving time setting mode. Here, an example of the G guide system in Osaka area of Japan will be described.

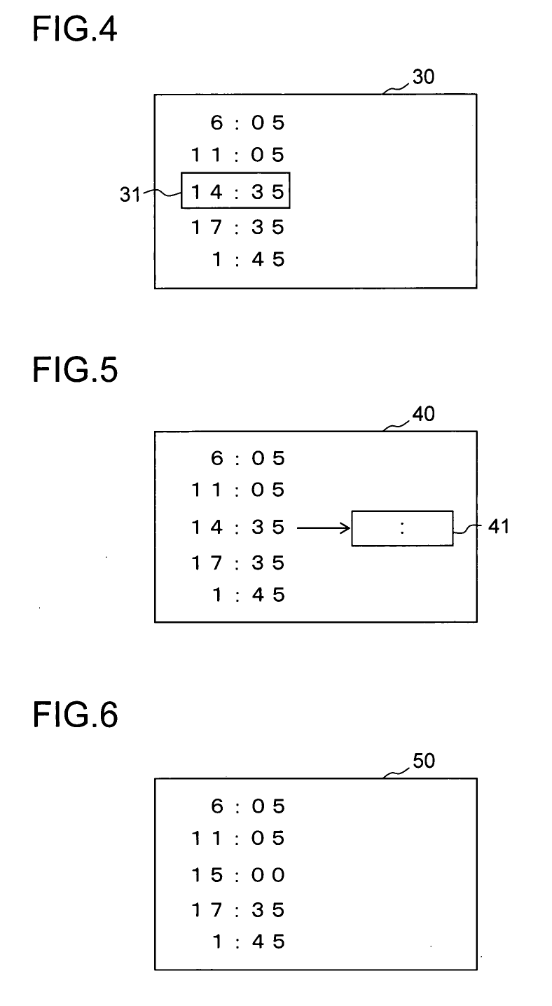

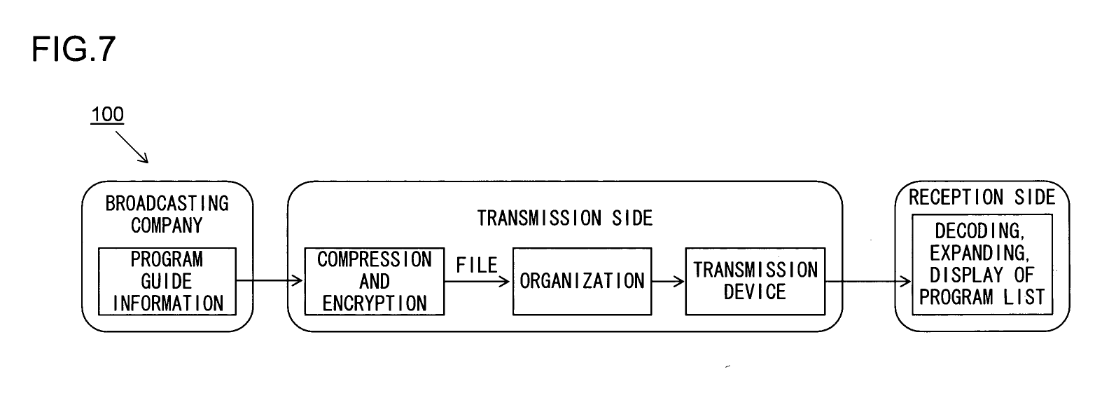

It is supposed that the user would like to change the set time for receiving the EPG when the user knows that broadcasting time of the EPG will be changed through a newspaper or other media. In this case, the user operates the remote controller 20 or the like to select the EPG receiving time setting mode on a menu screen. Then, the DVD recorder 10 activates the EPG receiving time setting mode and reads out the EPG receiving time from the ROM 16b in the step S10 so that the EPG receiving time setting screen is output and displayed on the monitor. FIG. 4 shows an example of the EPG receiving time setting screen. A screen 30 displays time when the EPG extraction portion 14 should be activated to start extraction of the EPG (broadcasting time of the EPG) and a cursor 31 for selecting each time, and the user is prompted to select time to be changed by using the cursor 31.

Then, the process goes from the step S10 to the step S11 in which it is checked whether or not time to be changed is selected. When the user puts the cursor 31 on the time to be changed and presses the Enter key (not shown), the process goes from step S11 to the step S12 in which the DVD recorder 10 outputs an input acceptance screen, which is displayed on the monitor. FIG. 5 shows an example of the input acceptance screen 40. FIG. 5 shows an example of the case where the receiving time 14:35 is selected. The screen 40 displays the EPG receiving time before the change and a blank field 41 for changing the selected time, and the user is prompted to input time after the change in the blank field 41.

Next, the process goes from the step S12 to the step S13 in which it is checked whether or not time after the change is input. When user inputs time after the change in the blank field 41 and presses the Enter key, the process goes from the step S13 to the step S14 in which the DVD recorder 10 outputs a list of the EPG receiving time after the change, which is displayed on the monitor. FIG. 6 shows an example of a schedule screen 50 of the EPG receiving time after the change. FIG. 6 is an example of the case where the receiving time 14:35 is changed to 15:00. The screen 50 displays the receiving time 15:00 after the change from 14:35 that was displayed on the screen 30 before the change.

Next, the process goes from the step S14 to the step S15 in which the EPG receiving time stored in the ROM 16b is updated to the receiving time after the change. Then, the EPG receiving time setting mode is finished. Thus, the EPG can be received not at the receiving time before the change (14:35) but at the receiving time after the change (15:00).

After that, when the receiving time after the change has passed, the EPG receiving time after the change stored in the ROM 16b is replaced with the receiving time before the change. In other words, the EPG receiving time after the change is valid only once. It is because the EPG will be transmitted the next day at the normal broadcasting time of the EPG, and the EPG should be received normally.

According to the embodiment described above, even if the broadcasting time of the EPG is changed, the EPG can be receive when the user changes the EPG receiving time manually. Thus, the user can use the latest EPG.

The broadcasting receiving device of the present invention can be provided to a television broadcasting receiving device, a video tape recorder, a DVD recorder, an HDD recorder, or the like and to a combination device of them.

What is claimed is:

1. An analog broadcasting receiving device comprising:
a receiving portion for receiving a television broadcasting wave;
an EPG extracting portion for extracting EPG data from VBI of the television broadcasting wave;
a memory portion for storing drive start time of the EPG extraction portion; and
a control portion for controlling each portion, wherein
the drive start time can be changed to desired time.

2. The analog broadcasting receiving device according to claim 1, wherein the drive start time after the change is valid only once.

3. A DVD recorder equipped with an analog broadcasting receiving device comprising:
a receiving portion for receiving a television broadcasting wave;
an EPG extracting portion for extracting EPG data from VBI of the television broadcasting wave;
a ROM for storing drive start time of the EPG extraction portion; and
a control portion for controlling each portion, wherein
a screen is output that prompts to change the drive start time to desired time, when the desired time is input, the drive start time before the change is deleted while drive start time after the change is stored, and when the drive start time after the change has passed, the drive start time after the change is deleted while the drive start time before the change is stored.
